(19) United States
(12) Patent Application Publication
(10) Pub. No.: US 2010/0194286 A1
(43) Pub. Date: Aug. 5, 2010

(54) SERIES-WIRED CHRISTMAS LIGHT STRING WITH OVERCURRENT PROTECTION

(75) Inventor: John L. Janning, Bellbrook, OH (US)

Correspondence Address: DICKSTEIN SHAPIRO LLP, 1825 EYE STREET NW, Washington, DC, 20006-5403, US

(73) Assignee: JLJ, Inc.

(21) Appl. No.: 12/759,558

(22) Filed: Apr. 13, 2010

Related U.S. Application Data
(60) Provisional application No. 61/340,065, filed on Mar. 12, 2010.
(60) Provisional application No. 61/338,223, filed on Feb. 16, 2010.
(60) Provisional application No. 61/280,799, filed on Nov. 9, 2009.
(60) Provisional application No. 61/338,400, filed on Feb. 18, 2010.

(51) Int. Cl. H05B 37/03

(52) U.S. Cl. 315/127

(57) ABSTRACT

A Christmas light string with a resettable fuse, preferably a positive coefficient thermistor, that prevents damage to the string when an overcurrent condition arises. An overcurrent condition in a light string may occur when lights burn out or when too many light strings are placed end to end. When an overcurrent condition exists, the resistance of the resettable fuse rises and reduces the current in the string to prevent damage to bulbs and glass fuses.

This application claims the benefit of U.S. Provisional Application No. 61/340,065, filed on Mar. 12, 2010; U.S. Provisional Application No. 61/338,223, filed on Feb. 16, 2010, U.S. Provisional Application No. 61/280,799, filed on Nov. 9, 2009, and U.S. Provisional Application No. 61/338,400, filed on Feb. 18, 2010, the entire disclosures of which are incorporated by reference herein.

### FIELD OF THE INVENTION

The present invention relates to series wired Christmas light strings with overcurrent protection and, more specifically, to a resettable fuse for a Christmas tree light string.

### BACKGROUND OF THE INVENTION

Incandescent Christmas light strings today are usually wired in electrical series connection. Most of these light strings contain 50 miniature 2.5 volt bulbs connected in electrical series. It has been standard practice to incorporate a type of shunt wiring inside each bulb so that in case of a bulb burning out, the oxidized shunt wiring will break down and keep current flowing in the series-wired light string. As more bulbs burn out, more current is supplied to the remaining bulbs in the light string. The life expectancy of these remaining bulbs decreases resulting in more failures. This culminates in a dangerous overcurrent condition.

In some series-wired light strings, as bulbs are removed or shorted out, current passes through shunts and an overcurrent condition can occur. If, for example, three bulbs are removed from such a light string, the life expectancy of the remaining bulbs in the string is decreased by over 50%. If someone foolishly removes a dozen bulbs or so—to make the remaining lights brighter—this could cause a problem. At that point, bulbs would start burning out faster. Each time a bulb burns out, the internal shunt inside the bulb shorts out, increasing even more current through the remaining bulbs in the light string. At some point, there is a runaway condition where bulbs start popping fast. Because of this, Underwriters Laboratory (UL) has not approved such a light string as described. To solve the problem, and get UL approval, these light manufacturers have inserted a bulb in the series-wired incandescent light string without the internal shunt wiring. When this bulb fails, it acts as a fuse and disables the entire light string. While this solves the problem, UL requires that this bulb be non-replaceable with other bulbs of its type. As a result, the light string ends up in the trash, since it is non-fixable by the average consumer.

Alternatively, light manufactures may install a small 3 ampere glass fuse in the plug of the light string to provide overcurrent protection. In these circumstances, when multiple bulbs burn out and the current increases to unsafe levels, the glass fuse blows to prevent an overcurrent condition. Such fuses also prevent dangerous overcurrent conditions that may occur when multiple strings are placed end to end. While such fuses may be replaced, the light string is, in the meantime, unusable.

Accordingly, it would desirable to provide a resettable device for preventing dangerous overcurrent conditions in a series-wired light string caused by burned out bulbs or by multiple strings being placed end to end.

### SUMMARY OF THE INVENTION

The present invention provides a resettable fuse for use in a series-wired Christmas light string. The resettable fuse is a positive temperature coefficient thermistor that is wired in electrical series connection with the bulbs in the Christmas light string. The resettable thermistor fuse may be housed within a plug of the Christmas light string or placed outside a plug of the light string between the bulbs in the light string.

The bulbs of the light string may be incandescent bulbs or light emitting diodes. Also, the resettable fuse may be enclosed within a thermal insulation material.

Other features and advantages will become apparent from the following description, which refers to the accompanying drawings.

### BRIEF DESCRIPTION OF THE DRAWINGS

FIG. 1 illustrates a resettable fuse within a plug; and

FIG. 2 illustrates a resettable fuse wired within a light string.

FIG. 3 illustrates a resettable fuse within a plug and connected in electrical series with a string of LED's.

### DETAILED DESCRIPTION OF THE PREFERRED EMBODIMENT

In the following detailed description, reference is made to a specific embodiment that may be practiced. This embodiment is described with sufficient detail to enable those skilled in the art to practice the invention and it is to be understood that other embodiments may be employed, and that structural and logical changes may be made without departing from the spirit or scope of the present invention.

The present invention is a resettable fuse comprised of a positive temperature coefficient (PTC) thermistor connected in electrical series with Christmas lights in a light string. The resettable fuse prevents overcurrent through the light string due to burned out bulbs and/or multiple light strings being connected end to end. Exemplary manufacturers of PTC thermistor resettable fuses include Bourns; EPCOS; and Littelfuse, for example.

During normal operation of a PTC thermistor, numerous carbon paths within the polymer of the thermistor allow the device to conduct electricity. As current through the thermistor reaches its rated threshold, the polymer material begins to heat causing the polymer to expand. The resulting expansion breaks the carbon chains to reduce the current through the circuit to a small leakage current. The increased resistance in the PTC thermistor works to protect circuitry by limiting potentially damaging current. When the fault (overcurrent) is removed from the circuit, and the power disconnected, the PTC thermistor will reset itself when it cools off and contracts to reestablish the carbon chains, thereby allowing current to flow through the circuit again when power is restored. As a result, once the burned out bulbs are replaced or the multiple strings are disconnected, the light string will be operable once again.

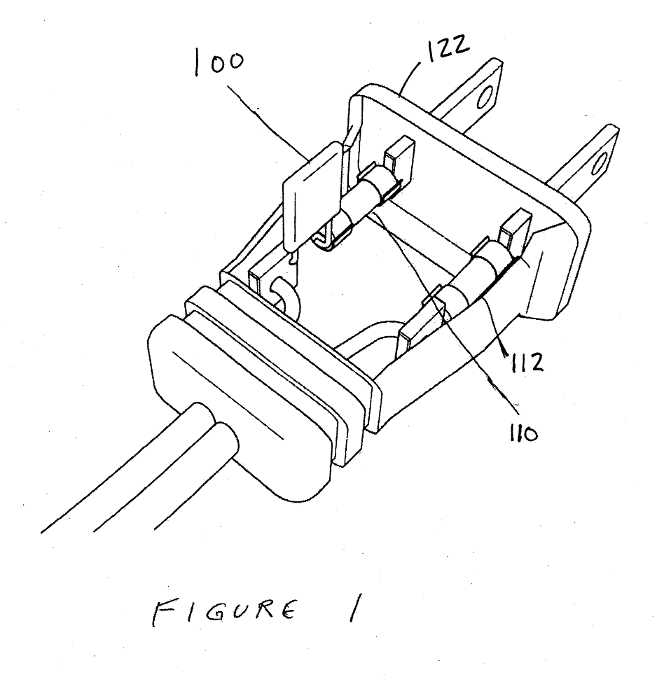

Referring now to the drawings, where like elements are designated by like reference numerals, FIG. 1 illustrates a 120 volt A.C. plug 122 containing two 3 ampere glass fuses 110, 112 with a resettable fuse 100 connected in series with the glass fuse 110. Along with the standard fuses 110, 112 in the 120 volt plug 122, the resettable fuse 100 protects from overcurrent in the Christmas light string. In another embodiment, there are no standard fuses but only the resettable fuse 100 in the plug 122. Further, in another embodiment, two resettable fuses 100 could each be connected in series with one of the glass fuses 110, 112.

In yet another embodiment, thermal insulation is placed around the resettable fuse 100. This is important for conditions where the 120 volt A.C. plug 122 may experience temperature extremes—especially very cold conditions. The resettable fuse 100 could also be placed inside of a “box” with air around it for insulation.

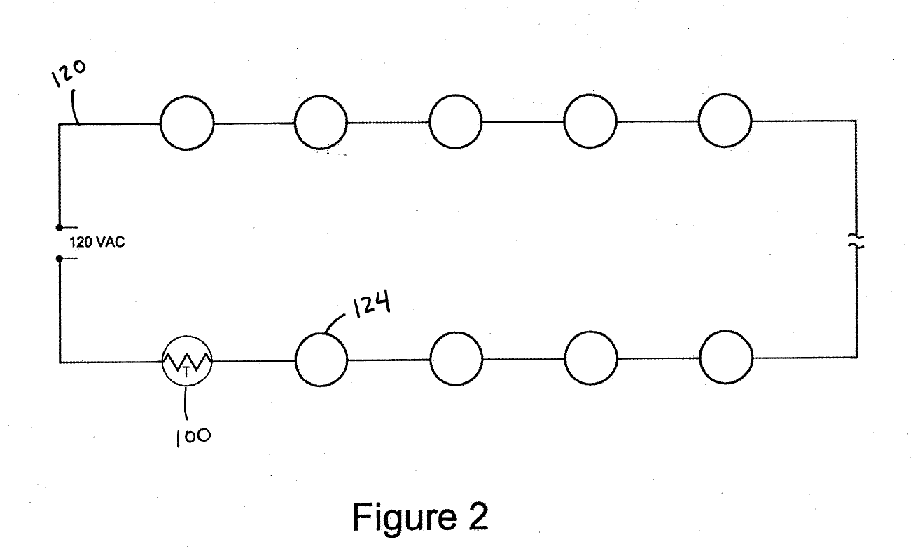

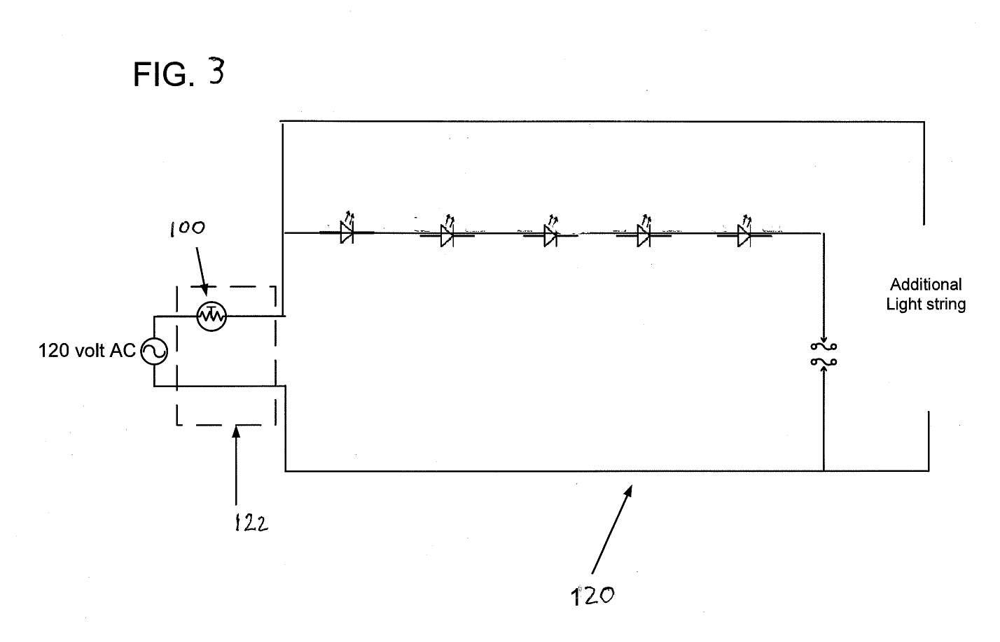

FIG. 2 illustrates the resettable fuse 100 connected in a series-wired Christmas light string wiring circuit 120 with individual bulbs 124. The resettable fuse 100 may be placed anywhere along the string wiring circuit 120, or preferably is disposed within the electrical plug as shown in FIG. 3.

The resettable fuse of the present invention is applicable to standard incandescent Christmas light strings as well as light emitting diodes (LED's) wired in electrical series connection, as shown in FIG. 3. As LED's fail, they usually fail in the shorted state and thus, more current flows through the light string causing an overcurrent condition. Thus, the resettable fuse may be used to prevent the overcurrent condition.

For strings on Christmas trees, the current rating of the thermistor (or resettable fuse) 100 can be low, such as 300 milliamperes trip current. This makes for a smaller size; lower cost and faster response time. Approximate current rating of the thermistor for strings for trees would be around 300 to 500 mA. For light strings, in general, the current rating should be higher than for trees, for example, around 2.5 A. When both a glass fuse 110 and a thermistor 100 are used, the thermistor rating should be slightly lower than the rating of the glass fuse so that the thermistor trips before the glass fuse. For LED light strings, the current rating can be much less than for incandescent lights. Incandescent light strings draw around 340 mA for 100 lights, while a 100 light LED string draws around 50 mA.

The above description and the drawings illustrate only exemplary and/or preferred embodiments that achieve various objectives, features, and advantages. It is not intended that the present invention be limited to the illustrated embodiments. Accordingly, the claims appended hereto should be read in their full scope including any such modifications, derivations and variations.

What is claimed as new and desired to be protected by Letters Patent of the United States is:

1. A series-wired Christmas light string, comprising:
a resettable fuse wired in electrical series connection with the Christmas lights,
wherein the resettable fuse is a positive temperature coefficient thermistor.

2. The light string of claim 1, wherein the resettable fuse is housed within a plug of the Christmas light string.

3. The light string of claim 1, wherein the resettable fuse is disposed outside a plug of the Christmas light string.

4. The light string of claim 3, wherein the resettable fuse is disposed between the bulbs in the Christmas light string.

5. The light string of claim 1, wherein the lights are incandescent bulbs.

6. The light string of claim 1, wherein the lights are light emitting diodes.

7. The light string of claim 1, wherein the resettable fuse is enclosed within a thermal insulation material.

8. The light string of claim 1, further comprising a glass fuse disposed in electrical series with the resettable fuse and the Christmas lights.

9. The light string of claim 8, wherein the resettable fuse and the glass fuse are both disposed within a plug of the Christmas light string.

10. A series-wired Christmas light string, comprising:
a resettable fuse wired in electrical series connection with the bulbs in the Christmas light string, wherein the resettable fuse is a positive temperature coefficient thermistor and is housed within a plug of the Christmas light string.

11. The light string of claim 10, wherein the lights of the string are incandescent bulbs.

12. The light string of claim 10, wherein the lights of the string are light emitting diodes.

13. The light string of claim 10, wherein the resettable fuse is enclosed within a thermal insulation material.

14. The light string of claim 10, further comprising a glass fuse disposed in the plug and wired in electrical series with the resettable fuse and the bulbs of the Christmas light string.
